(19) United States
(12) Patent Application Publication
(10) Pub. No.: US 2025/0371889 A1
(43) Pub. Date: Dec. 4, 2025

(54) FOOD MANAGEMENT METHOD, RECORDING MEDIUM, FOOD MANAGEMENT SYSTEM, AND FOOD MANAGEMENT TAG

(71) Applicant: Panasonic Intellectual Property Management Co., Ltd., Osaka (JP)

(72) Inventors: Mitsuhiro ASO, Osaka (JP); Gantetsu MATSUI, Hyogo (JP)

(21) Appl. No.: 18/876,471

(22) PCT Filed: Jun. 8, 2023
(86) PCT No.: PCT/JP2023/021379

§ 371 Date: Dec. 18, 2024

(30) Foreign Application Priority Data
Jun. 28, 2022 (JP) 2022-103900

(51) Int. Cl. G06V 20/68; G06V 30/14

(52) U.S. Cl. CPC G06V 20/68; G06V 30/1429

(57) ABSTRACT

A food management method includes acquiring an image captured by imaging, using an imaging element, food or a storage container to which a food management tag including an identifier associated with the food is attached, and the storage container stores the food. The food management method includes recognizing, based on the image acquired, the food or the storage container to which the food management tag is attached. The food management method includes estimating the remaining amount of the food based on the size of the food management tag recognized. The food management method includes outputting remaining amount information related to the remaining amount of the food that has been estimated.

### TECHNICAL FIELD

The present disclosure relates to a food management method, a program, a food management system, and a food management tag for managing food.

### BACKGROUND ART

Patent Literature (PTL) 1 discloses a determination device which determines the storage or removal of an item (food) in a storage device (refrigerator),

### CITATION LIST

### Patent Literature

[PTL] Japanese Unexamined Patent Application Publication No. 2016-023584

### SUMMARY OF INVENTION

### Technical Problem

The present disclosure provides a food management method and the like which easily manage food.

### Solution to Problem

A food management method according to an aspect of the present disclosure includes acquiring an image captured by imaging, using an Imaging element, food or a storage container to which a food management tag including an identifier associated with the food is attached, and the storage container stores the food. The food management method includes recognizing, based on the image acquired, the food or the storage container to which the food management tag is attached. The food management method includes estimating the remaining amount of the food based on the size of the food management tag recognized. The food management method includes outputting remaining amount information related to the remaining amount of the food that has been estimated,

A program according to an aspect of the present disclosure causes one or more processors to execute the food management method.

A food management system according to an aspect of the present disclosure includes an acquirer, a recognizer, an estimator, and an outputter. The acquirer acquires an image captured by imaging, using an imaging element, food or a storage container to which a food management tag including an identifier associated with the food Is attached, and the storage container stores the food. The recognizer recognizes, based on the image acquired by the acquirer, the food or the storage container to which the food management tag is attached. The estimator estimates a remaining amount of the food based on a size of the food management tag recognized by the recognizer. The outputter outputs remaining amount information related to the remaining amount of the food that has been estimated by the estimator.

A food management tag according to an aspect of the present disclosure is a food management tag that is attached to food or a storage container for storing the food and includes an identifier associated with the food, and the food management tag includes: a variable part, a size of which is variable according to a remaining amount of the food.

### Advantageous Effects of Invention

A food management method and the like according to the present disclosure provide an advantage in that food is easily managed.

### BRIEF DESCRIPTION OF DRAWINGS

FIG. 1 is a block diagram showing an overall configuration Including a food management system in Embodiment 1.

FIG. 2 is a diagram showing a first use example of a food management tag in Embodiment 1.

FIG. 3 is a diagram showing a second use example of the food management tag in Embodiment 1.

FIG. 4 is a flowchart showing an operation example of the food management system in Embodiment 1.

FIG. 5 is a block diagram showing an overall configuration including a food management system in a variation of Embodiment 1.

FIG. 6 is a block diagram showing an overall configuration Including a food management system in Embodiment 2.

FIG. 7 is a diagram showing a use example of a food management tag in Embodiment 2.

FIG. 8 is a diagram showing an example of the food management tag in Embodiment 2.

FIG. 9 is a flowchart showing an operation example of the food management system in Embodiment 2.

### DESCRIPTION OF EMBODIMENTS

### Underlying Knowledge Forming Basis of the Present Disclosure

The point of view of the inventors will first be described below.

A technique is known in which as in the technique disclosed in PTL 1, an image including food is captured, image recognition processing is appropriately performed on the captured image, and thus the food is recognized. For example, when the technique as described above is used to manage food stored in a refrigerator, the following issue arises.

Specifically, for example, the shape and the size of food are greatly changed depending on usage conditions such as a case where a part of the food is used in cooking. Hence, disadvantageously, in the technique described above, for example, it is difficult to determine whether unused food and food which has been partially used in cooking are the same food. Moreover, disadvantageously, in the technique described above, it is difficult to determine whether food is the same before and after use, and thus it is naturally difficult to grasp the remaining amount of food.

Here, for example, it is conceivable to identify food using radio frequency identifier (RFID) technology by attaching a radio frequency (RF) tag to the food. However, disadvantageously, RF tags are not widely used, and thus it is not realistic to attach RF tags to all food Items. Furthermore, disadvantageously, even if RF tags are attached to food, it is still not possible to grasp the remaining amount of food.

In view of the foregoing, the inventors have devised the present disclosure.

Embodiments will be described in detail below with reference to drawings as necessary. However, detailed descriptions beyond necessity may be omitted. For example, detailed descriptions of already well-known matters or repeated descriptions of substantially the same configuration may be omitted. This is intended to avoid unnecessary redundancy in the following description and to facilitate the understanding of those skilled in the art,

The inventors provide the accompanying drawings and the following description to cause those skilled in the art to fully understand the present disclosure, and they are not intended to limit subject matters described in the scope of claims.

### Embodiment 1

### [1-1. Overall Configuration]

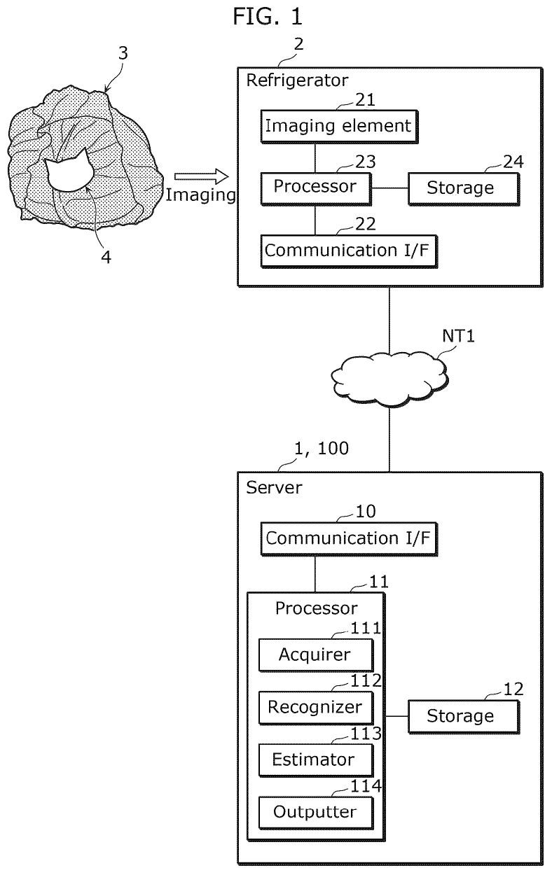

An overall configuration which includes food management system 100 in Embodiment 1 will first be described with reference to FIG. 1. FIG. 1 is a block diagram showing the overall configuration Including food management system 100 in Embodiment 1. In Embodiment 1, food management system 100 is used to manage the remaining amount of food 3 stored in refrigerator 2, that is, the amount of food 3 used. For example, food 3 may be directly stored in refrigerator 2 or may be stored in refrigerator 2 in a state where food 3 is stored in storage container 5 (see FIG. 3) for storing food 3. In Embodiment 1, food 3 or storage container 5 is stored in refrigerator 2 in a state where food management tag 4 is attached thereto.

Food management tag 4 is attached to food 3 or storage container 5 for storing food 3, and includes an identifier associated with food 3. The identifier described here may be a specific character string such as a so-called identifier (ID) number, or may simply be a unique feature with which food management tag 4 can distinguished from the other food management tags. More specifically, the identifier may be in a form in which a result obtained by performing image recognition processing on an image of a food management tag in recognizer 112 of food management system 100 described later can be distinguished from results obtained by performing the image recognition processing on images of the other food management tags.

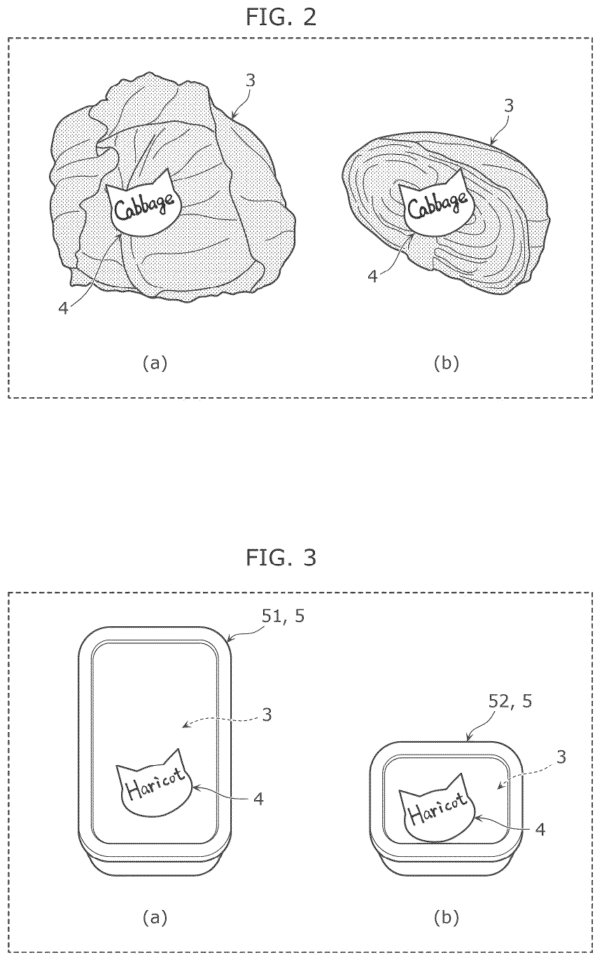

In Embodiment 1, for example, food management tag 4 is a sticky note in the shape of a cat, and a character string indicating the name of food 3 (see FIG. 2, here, a character string of “cabbage”) is written. In other words, in Embodiment 1, the identifier of food management tag 4 is a combination of the shape of food management tag 4 and the character string written on food management tag 4.

For example, the identifier of food management tag 4 may be the character string itself written on food management tag 4, may be the shape of food management tag 4 itself, or may be a pattern itself applied to food management tag 4. The identifier of food management tag 4 may be a combination of two or more of the shape, the pattern, and the character string. In Embodiment 1, food management tag 4 may be a RF tag.

For example, food management tag 4 is attached to food 3 or storage container 5 by sticking a surface coated with an adhesive to any part of food 3 or storage container 5. For example, as described above, food management tag 4 may be directly stuck to food 3 or storage container 5, or may be attached to food 3 or storage container 5 using, for example, a rubber band or a clip. For example, food management tag 4 may be stuck to the package of food 3.

Refrigerator 2 includes imaging element 21, communication Interface (hereinafter referred to as a communication interface (I/F)) 22, processor 23, and storage 24. Refrigerator 2 may include a refrigerator compartment having a door, the drawer of a vegetable compartment, or the like. Although in Embodiment 1, imaging element 21, communication I/F 22, processor 23, and storage 24 are provided in refrigerator 2, they may be provided around refrigerator 2 as separate devices.

Imaging element 21 is, for example, an image sensor such as a charged coupled device (CCD) sensor or a complementary metal oxide semiconductor (CMOS) sensor, and is used to image food 3 or storage container 5 to which food management tag 4 is attached. For example, imaging element 21 is installed inside refrigerator 2, in the door of refrigerator 2, or in a member which protrudes from the top plate of refrigerator 2 toward a door side.

Imaging element 21 may be provided inside refrigerator 2 or may be provided outside refrigerator 2. Imaging element 21 does not need to be previously provided in refrigerator 2, and may be additionally provided, Imaging element 21 may be portable by a user. In this case, the user may hold imaging element 21 to image food management tag 4. Furthermore, imaging element 21 may be Independent or may be incorporated into a device such as a mobile terminal having an imaging function.

For example, a plurality of imaging elements 21 may be provided, and examples thereof include imaging element 21 for a refrigerator compartment, imaging element 21 for a freezer compartment, imaging element 21 for a drawer, and the like. When a plurality of imaging elements 21 are provided, processor 23 may determine with which one of Imaging elements 21 an image is acquired.

Furthermore, as will be described later, imaging element 21 may be used to image another target such as the user in addition to an application for imaging food 3 or storage container 5 to which food management tag 4 is attached, When imaging element 21 for Imaging the user is used, it is possible to determine the user based on an image captured by Imaging the user.

For example, the opening or closing of the door of refrigerator 2 by the user is used as a trigger for imaging, using imaging element 21, food 3 or storage container 5 to which food management tag 4 is attached. Specifically, imaging element 21 may image food 3 or storage container 5 to which food management tag 4 is attached during a period in which the door of refrigerator 2 is opened. For example, imaging element 21 may image food 3 or storage container 5 which is outside refrigerator 2 and to which food management tag 4 is attached for a certain period of time after detecting that the door of refrigerator 2 has been closed. For example, imaging element 21 may also image food 3 or storage container 5 which is inside refrigerator 2 and to which food management tag 4 is attached after a certain period of time has elapsed since it was detected that the door of refrigerator 2 had been closed. Imaging element 21 may also constantly image food 3 or storage container 5 regardless of whether refrigerator 2 is opened or closed. Hence, an image is captured by imaging, using imaging element 21, food 3 or storage container 5 at a timing at which the user puts food 3 or storage container 5 into refrigerator 2 (storage space) or the user removes food 3 or storage container 5 from refrigerator 2,

For example, communication I/F 22 communicates with communication I/F 10 of food management system 100 via external network NT1 such as the Internet. The communication between communication I/F 22 and communication I/F 10 of food management System 100 may be wired communication instead of wireless communication. The standards for the communication between communication I/F 22 and food management system 100 are not particularly limited. When imaging element 21 images food 3 or storage container 5 to which food management tag 4 is attached, communication I/F 22 transmits data of an image captured by the Imaging to communication I/F 10 of food management system 100.

Processor 23 controls the operation of refrigerator 2. Processor 23 includes a memory, and executes programs stored in the memory to achieve various functions.

Storage 24 is a storage device in which information (such as computer programs) necessary for executing various functions with processor 11 is stored. Although storage 12 is realized by, for example, a semiconductor memory, storage 12 is not particularly limited to the semiconductor memory, and a known electronic information storage can be used. For example, storage 12 stores data of the image captured by imaging element 21 and the like,

### [1-2. Food Management System]

Food management system 100 will then be described in detail. In Embodiment 1, food management system 100 includes, for example, server 1 which is installed in a remote location away from a facility where refrigerator 2 is installed (here, a house where the user lives). Food management system 100 may further include refrigerator 2 in addition to server 1.

Although in the description of Embodiment 1, one refrigerator 2 is the target of food management system 100, a plurality of refrigerators 2 may be the targets of food management system 100.

As shown in FIG. 1, food management system 100 (server 1) includes communication I/F 10, processor 11, and storage 12.

Communication I/F 10 has the function of communicating with communication I/F 22 of refrigerator 2 via external network NT1 as has already been described above. Communication I/F 10 receives the data of the image captured by imaging element 21 which is transmitted from communication I/F 22 of refrigerator 2. The data of the captured image which is received by communication I/F 10 Is fed to processor 11.

Processor 11 includes a memory, and executes programs stored in the memory to achieve various functions. Specifically, processor 11 executes the programs stored in the memory to function as acquirer 111, recognizer 112, estimator 113, and outputter 114. In other words, food management system 100 includes acquirer 111, recognizer 112, estimator 113, and outputter 114,

Acquirer 111 acquires the image captured by imaging, using imaging element 21, food 3 or storage container 5 to which food management tag 4 is attached. In Embodiment 1, acquirer 111 acquires, via communication I/F 10, the data of the captured image transmitted from communication I/F 22 of refrigerator 2.

Recognizer 112 recognizes, based on the captured image acquired by acquirer 111, food 3 or storage container 5 to which food management tag 4 is attached. Specifically, recognizer 112 appropriately performs the image recognition processing on the captured image acquired by acquirer 111 to recognize an image of the part of food management tag 4 included in the captured image and to recognize an image of the part of food 3 or storage container 5 Included in the captured image. Here, recognizer 112 recognizes, as the identifier of food management tag 4, the part of food management tag 4 Included in the captured image. The identifier of food management tag 4 recognized by recognizer 112 and the image of the part of food 3 or storage container 5 recognized by recognizer 112 are stored in storage 12 as data in which they are associated with each other. In this way, the identifier of food management tag 4 and the image of the part of food 3 or storage container 5 to which food management tag 4 is attached are stored in storage 12 in association with each other.

In Embodiment 1, recognizer 112 further recognizes the type of food 3 based on the captured image acquired by acquirer 111. Hence, in Embodiment 1, the identifier of food management tag 4 is associated with the image of the part of food 3 or storage container 5 to which food management tag 4 is attached, and is further associated with the type of food 3, and they are stored in storage 12. For example, recognizer 112 uses a trained model which has been machine-trained to receive an image of food 3 as an input and to output the type of food 3, and thereby can recognize the type of food 3.

Estimator 113 estimates the remaining amount of food 3 based on the size of food management tag 4 recognized by recognizer 112. In Embodiment 1, estimator 113 compares the size of food management tag 4 recognized by recognizer 112 with the size of food 3 or storage container 5 recognized by recognizer 112 to estimate the remaining amount of food 3. Specifically, estimator 113 estimates the remaining amount of food 3 based on the ratio of the area of a region recognized as food 3 or storage container 5 in the captured image to the area of a region recognized as food management tag 4 in the captured image. The area of the region described here may be the number of pixels included in the region. The remaining amount of food 3 estimated by estimator 113 is stored in storage 12 in association with the identifier of food management tag 4 and food 3 to which food management tag 4 is attached.

The remaining amount of food 3 may be stored in storage 12 in association with the registration date of food 3 or an update date on which the remaining amount of food 3 is updated. The remaining amount of food 3 may be stored in storage 12 in association with a storage location in refrigerator 2. Furthermore, when a plurality of imaging elements 21 are provided, the remaining amount of food 3 may be stored in storage 12 in association with information for identifying with which one of imaging elements 21 food 3 is imaged.

When the user can be determined based on the image captured by imaging element 21, the remaining amount of food 3 may be stored in storage 12 in association with the identifier of the user. In this case, for example, even when the user is located away from refrigerator 2 because the user is out, the user uses an Information terminal such as a smartphone owned by the user to be able to browse various types of information including the remaining amount of food 3 associated with the identifier of the user. When the user browses the various types of information, the user operates the information terminal to be able to modify at least a part of the various types of information.

For example, when the remaining amount of food 3 is stored in storage 12 in association with only the identifier of the user, the registration date, the update date, the storage location in refrigerator 2, the information for identifying with which one of imaging elements 21 food 3 is imaged, and the like may be additionally associated with the remaining amount of food 3.

In other words, since in Embodiment 1, the size of food management tag 4 is not changed, the size is naturally not changed before and after the use of food 3. On the other hand, for example, as food 3 is used in cooking or the like, the size thereof is decreased. For example, it is likely that as food 3 is used in cooking or the like, food 3 is transferred to a smaller storage container, and thus the size thereof is decreased. Hence, it is possible to estimate the remaining amount of food 3 by determining the ratio of the size of food 3 or storage container 5 to the size of food management tag 4.

FIG. 2 is a diagram showing a first use example of food management tag 4 In Embodiment 1. FIG. 2 shows an image captured by imaging, using imaging element 21, food 3 to which food management tag 4 is attached. In the example shown in FIG. 2, food 3 is cabbage, and food management tag 4 is a sticky note on which “cabbage” is written and which is formed in the shape of a cat. In the captured image shown in part (a) in FIG. 2, food 3 is not used. In the captured image shown in part (b) in FIG. 2, a half of food 3 has been used in cooking or the like.

For example, it is assumed that acquirer 111 acquires the captured image shown in part (a) in FIG. 2 at a timing at which the user first stores food 3 in refrigerator 2. In this case, estimator 113 estimates that the remaining amount of food 3 is 100%. Estimator 113 calculates, as “a”, the ratio of the area of the region recognized as food 3 to the area of the region recognized as food management tag 4 in the captured image shown in part (a) in FIG. 2. The ratio is stored in storage 12 in association with the identifier of food management tag 4 and food 3 to which food management tag 4 is attached.

For example, it is assumed that acquirer 111 acquires the captured image shown in part (b) in FIG. 2 at a timing at which the user removes, from refrigerator 2, food 3 to which food management tag 4 is attached, and then stores food 3 into refrigerator 2 again. In this case, estimator 113 calculates, as “α/2”, the ratio of the area of the region recognized as food 3 to the area of the region recognized as food management tag 4 in the captured image shown in part (b) in FIG. 2. Then, estimator 113 estimates that the remaining amount of food 3 is 50% by comparison with “α” which is read from storage 12 and at which the remaining amount of food 3 is 100%.

Here, with each timing at which imaging is performed using imaging element 21, a distance from food 3 to which food management tag 4 is attached to imaging element 21 can be changed. Hence, the area of the region recognized as food management tag 4 in the captured image and the area of the region recognized as food 3 can be changed each time imaging is performed using imaging element 21. In Embodiment 1, estimator 113 utilizes that the size of food management tag 4 is not changed, and thereby estimates the remaining amount of food 3 based on the ratio of the area of the region recognized as food 3 to the area of the region recognized as food management tag 4 In the captured image. Hence, even when the area of the region recognized as food management tag 4 in the captured image and the area of the region recognized as food 3 are changed with each timing at which imaging is performed using Imaging element 21, it is possible to estimate the remaining amount of food 3.

FIG. 3 is a diagram showing a second use example of food management tag 4 in Embodiment 1. FIG. 3 shows an image captured by imaging, using imaging element 21, storage container 5 to which food management tag 4 is attached. In the example shown in FIG. 3, food 3 is haricot and is stored in storage container 5, In the example shown in FIG. 3, food management tag 4 is a sticky note on which “haricot” is written and which is formed in the shape of a cat. In the captured image shown in part (a) in FIG. 3, food 3 is not used and is stored in first storage container 51. In the captured Image shown in part (b) in FIG. 3, a half of food 3 has been used in cooking or the like, and the remaining half is stored In second storage container 52, the size of which is a half of the first storage container.

For example, it is assumed that acquirer 111 acquires the captured image shown in part (a) in FIG. 3 at a timing at which the user first stores storage container 5 (first storage container 51) in refrigerator 2. In this case, estimator 113 estimates that the remaining amount of food 3 is 0%. Estimator 113 calculates, as “β”, the ratio of the area of the region recognized as storage container 5 (first storage container 51) to the area of the region recognized as food management tag 4 in the captured image shown in part (a) in FIG. 3. The ratio is stored in storage 12 in association with the identifier of food management tag 4 and food 3 to which food management tag 4 Is attached.

For example, it is assumed that acquirer 111 acquires the captured image shown in part (b) in FIG. 2 at a timing at which the user removes, from refrigerator 2, storage container 5 (first storage container 51) to which food management tag 4 is attached, thereafter transfers food 3 to separate storage container 5 (second storage container 52), and stores storage container 5 in refrigerator 2. In this case, estimator 113 calculates, as “β/2”, the ratio of the area of the region recognized as storage container 5 (second storage container 52) to the area of the region recognized as food management tag 4 in the captured image shown in part (b) in FIG. 3. Then, estimator 113 estimates that the remaining amount of food 3 is 50% by comparison with “β” which is read from storage 12 and at which the remaining amount of food 3 is 0%,

Here, with each timing at which imaging is performed using imaging element 21, a distance from storage container 5 to which food management tag 4 is attached to imaging element 21 can be changed, Hence, the area of the region recognized as food management tag 4 in the captured image and the area of the region recognized as storage container 5 can be changed each time imaging is performed using imaging element 21. In Embodiment 1, estimator 113 utilizes that the size of food management tag 4 is not changed, and thereby estimates the remaining amount of food 3 based on the ratio of the area of the region recognized as storage container 5 to the area of the region recognized as food management tag 4 in the captured image. Hence, even when the area of the region recognized as food management tag 4 in the captured image and the area of the region recognized as storage container 5 are changed with each timing at which Imaging is performed using imaging element 21, it is possible to estimate the remaining amount of food 3.

It is conceivable that storage container 5 is a transparent container, and thus food 3 stored in storage container 5 can be imaged using imaging element 21. In this case, estimator 113 can estimate the remaining amount of food 3 by comparing the size of food management tag 4 recognized by recognizer 112 with the size of food 3 stored in storage container 5 recognized by recognizer 112.

It is conceivable that in a state where the lid of storage container 5 is closed, food 3 stored in storage container 5 cannot be imaged using imaging element 21. In this case, the user images the interior of storage container 5 using imaging element 21 in a state where the lid is opened, and thus estimator 113 can estimate the remaining amount of food 3 by comparing the size of food management tag 4 recognized by recognizer 112 with the size of food 3 stored in storage container 5 recognized by recognizer 112,

Outputter 114 outputs remaining amount information related to the remaining amount of food estimated by estimator 113, The remaining amount information may include, for example, information indicating the remaining amount of food 3 with the assumption that the remaining amount is 100% when food 3 is not used, and Information Indicating the amount of food 3 used. The remaining amount information may also include, in addition to information directly indicating the remaining amount of food 3, information which indicates whether a sufficient amount of food 3 Is left or a slight amount of food 3 is left and which is notified to the user.

In Embodiment 1, for example, outputter 114 periodically outputs (transmits) the remaining amount information to the information terminal owed by the user via communication I/F 10. For example, when communication I/F 10 receives a request signal from the information terminal, outputter 114 outputs (transmits) the remaining amount information to the information terminal via communication I/F 10. For example, the user performs a predetermined operation with the information terminal, and thus the request signal is transmitted from the information terminal to communication I/F 10. When refrigerator 2 includes a display, outputter 114 may output (transmit) the remaining amount information to refrigerator 2 via communication I/F 10. In this case, processor 23 of refrigerator 2 may display the remaining amount information acquired via communication I/F 22 on the display,

Storage 12 is a storage device in which information (such as computer programs) necessary for executing various functions with parts of processor 11 is stored. Although storage 12 is realized by, for example, a semiconductor memory, storage 12 is not particularly limited to the semiconductor memory, and a known electronic information storage can be used. Storage 12 stores data and the like where the identifier of food management tag 4 and food 3 to which food management tag 4 is attached are associated with each other.

### [2. Operation]

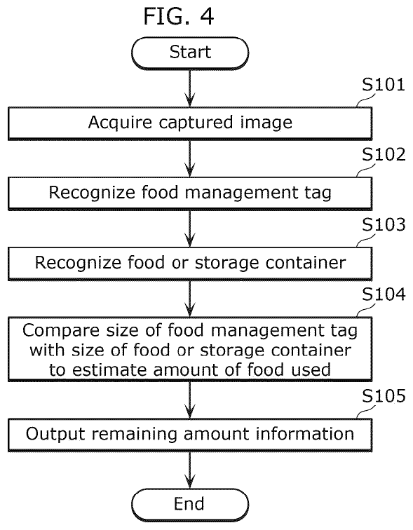

An operation (food management method) of food management system 100 configured as described above will be described below with reference to FIG. 4. FIG. 4 is a flowchart showing an operation example of food management system 100 in Embodiment 1. Acquirer 111 first acquires an image captured by imagining, using imaging element 21, food 3 or storage container 5 to which food management tag 4 is attached (S101). Here, acquirer 111 acquires, via communication I/F 10, data of the captured image transmitted from communication I/F 22 of refrigerator 2.

Then, recognizer 112 recognizes food management tag 4 Included in the captured image based on the captured image acquired by acquirer 111 (S102). Recognizer 112 also recognizes food 3 or storage container 5 included in the captured image based on the captured image which has been acquired (S103). The order of processing steps S102 and S103 is not limited to this order, and they may be performed in a reverse order or may be performed at the same time.

Then, estimator 113 compares the size of food management tag 4 recognized by recognizer 112 with the size of food 3 or storage container 5 recognized by recognizer 112 to estimate the remaining amount of food 3 (S104), Then, outputter 114 outputs remaining amount Information related to the remaining amount of food 3 estimated by estimator 113 (S105).

### [3. Advantage and Like]

An advantage of food management system 100 (food management method) in Embodiment 1 will be described below.

As has already been described, disadvantageously, in the technique in which an image including food is captured, image recognition processing is appropriately performed on the captured image, and thus the food is recognized, it is difficult to determine whether the food is the same before and after use, with the result that it is difficult to estimate the remaining amount of food. Moreover, disadvantageously, in a method of attaching a RF tag to food to identify the food using the RFID technology, the remaining amount of food cannot be grasped.

By contrast, in food management system 100 (food management method) in Embodiment 1, food 3 or storage container 5 to which food management tag 4 is attached is recognized, and thus it is possible to determine whether food 3 is the same before and after use. In food management system 100 (food management method) in Embodiment 1, the remaining amount of food 3 can be estimated based on the size of food management tag 4 which has been recognized (in particular, in Embodiment 1, by comparing the size of food management tag 4 which has been recognized with the size of food 3 or storage container 5 which has been recognized).

Hence, advantageously, in food management system 100 (food management method) in Embodiment 1, the remaining amount of food 3 can be grasped by referencing the remaining amount of food 3 which has been estimated, and thus food 3 is easily managed as compared with a case where food 3 is simply identified.

### [4. Variation of Embodiment 1]

A variation of Embodiment 1 will be illustrated below.

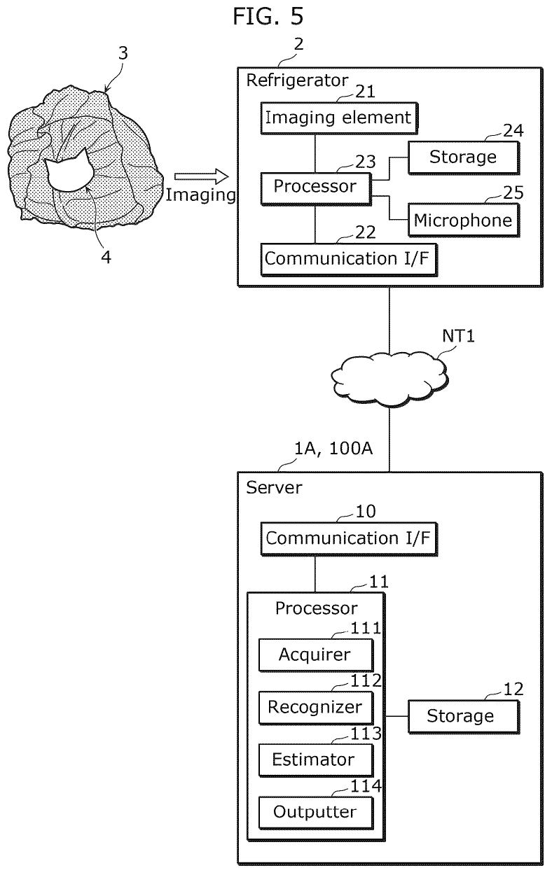

FIG. 5 is a block diagram showing an overall configuration Including food management system 100A in the variation of Embodiment 1. Food management system 100A includes server 1A, The configuration of server 1A is the same as that of server 1. As shown in FIG. 5, in the present variation, refrigerator 2 further Includes microphone 25. Food management system 100A in the present variation differs from food management system 100 in Embodiment 1 in that acquirer 111 further acquires sound Information which is collected by microphone 25 and is related to the remaining amount of food 3. Food management system 100A in the present variation differs from food management system 100 in Embodiment 1 in that outputter 114 includes, in the remaining amount information, Information which is based on the sound information acquired by acquirer 111 and is related to the remaining amount of food 3, and outputs the information.

For example, microphone 25 collects sound emitted by the user at a timing at which the user puts food 3 or storage container 5 into refrigerator 2 (storage space) or the user removes food 3 or storage container 5 from refrigerator 2. For example, when the user stores, as food 3, one head of cabbage into refrigerator 2, the user emits the sound of “one head of cabbage”. In this way, acquirer 111 acquires the sound information indicating “one head of cabbage” together with the captured image of cabbage (food 3) to which food management tag 4 or 4A is attached. Then, the identifier of food management tag 4 or 4A recognized by recognizer 112, recognition data of cabbage (food 3) recognized by recognizer 112, and the sound information Indicating “one head of cabbage” are stored in storage 12 in association with each other.

Then, outputter 114 can include the sound information in the remaining amount information to output the information. In other words, outputter 114 can output the remaining amount information Including the recognition data of cabbage (food 3) recognized by recognizer 112, the remaining amount of cabbage (food 3) estimated by estimator 113, and the sound information indicating “one head of cabbage”.

In the remaining amount information, the sound information indicating “one head of cabbage” is data which indicates the actual remaining amount of cabbage (food 3). Hence, for example, when estimator 113 uses a trained model which has been machine-trained to receive, as an input, the captured Image of food 3 or storage container 5 to which food management tag 4 or 4A is attached and to output the remaining amount of food 3, and thereby estimates the remaining amount of food 3, the remaining amount information described above can be used as training data when the trained model is retrained. In other words, this is because the sound information in the remaining amount Information indicates the actual remaining amount of food 3, and thereby serves as correct data. Hence, advantageously, in food management system 100A in the present variation, a data set for retraining with the actual remaining amount of food 3 used as the correct data is easily collected.

The trained model described above may be further machine-trained to output the type of food 3. In this case, the remaining amount information described above can also be used as training data when the trained model is retrained. In other words, this is because the sound information in the remaining amount information indicates the type of food 3, and thereby serves as correct data.

### Embodiment 2

### [1. Configuration]

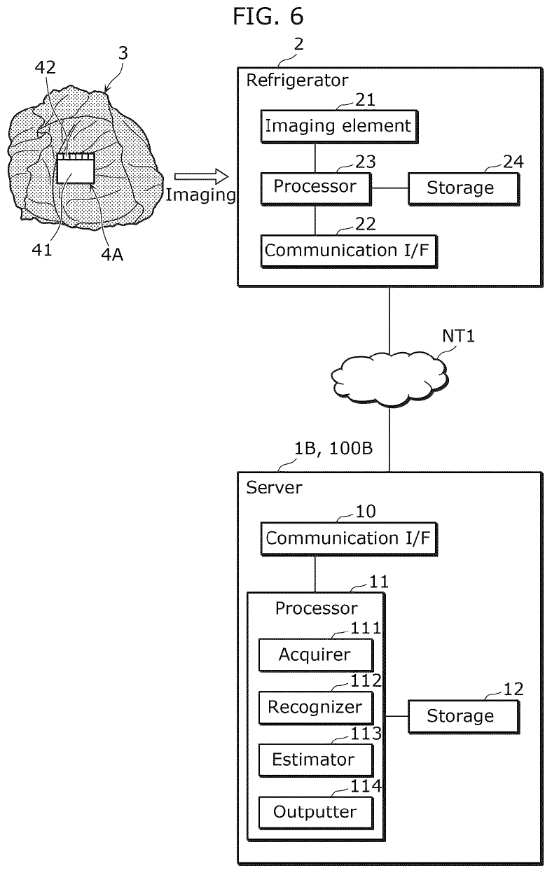

Food management system 100B in Embodiment 2 will be described below with reference to FIG. 6. FIG. 6 is a block diagram showing an overall configuration including food management system 100B in Embodiment 2. Food management system 100B in Embodiment 2 includes server 1B. The configuration of server 1B is the same as that of server 1. As shown in FIG. 6, in food management system 100B in Embodiment 2, it is assumed that food management tag 4A is attached to food 3 or storage container 5. Food management system 100B in Embodiment 2 differs from food management system 100 in Embodiment 1 in that recognizer 112 estimates the remaining amount of food 3 based on the size of variable part 42 of food management tag 4A recognized by recognizer 112.

In other words, In Embodiment 2, estimator 113 estimates the remaining amount of food 3 based on only the size of food management tag 4A (here, the size of variable part 42) without reference to the size of food 3 or storage container 5.

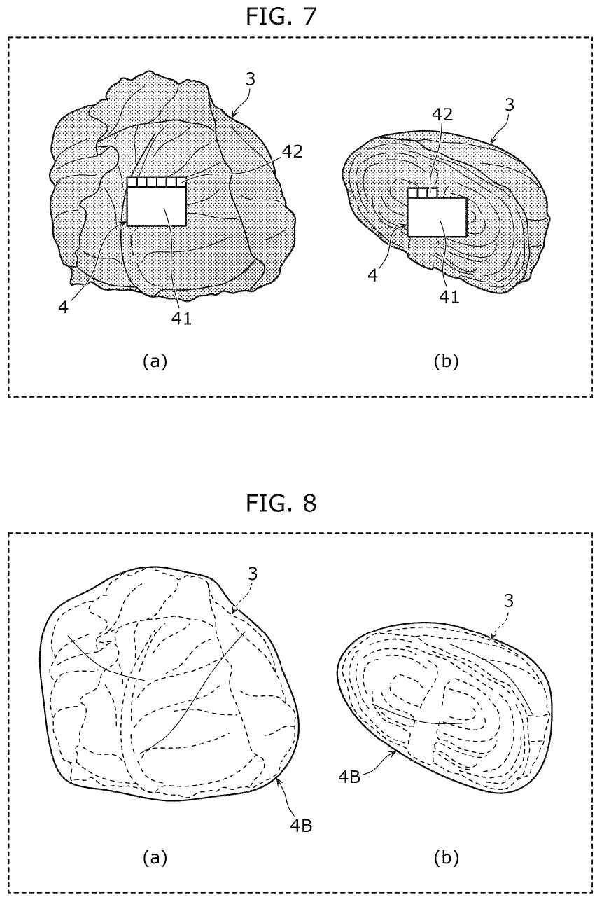

FIG. 7 is a diagram showing a use example of food management tag 4A in Embodiment 2. FIG. 7 shows an image captured by imaging, using imaging element 21, food 3 to which food management tag 4A is attached. In the example shown in FIG. 7, food 3 is cabbage, In the captured image shown in part (a) in FIG. 7, food 3 is not used, In the captured image shown in part (b) in FIG. 7, a half of food 3 has been used in cooking or the like.

As shown in FIG. 7, food management tag 4A in Embodiment 2 is a sticky note in a rectangular shape as a whole, and includes invariable part 41 and variable part 42. For example, invariable part 41 includes a blank space in which a character string for food 3 or the like is written, and the size thereof is not changed. Variable part 42 includes a plurality of (here, six) removable small pieces, and the size thereof can be changed. For example, the user removes a small piece such as by tearing off the small piece according to the remaining amount of food 3, and thus the size of variable part 42 can be changed.

In other words, food management tag 4A Includes variable part 42 the size of which can be changed according to the remaining amount of food 3. In variable part 42, the user can remove the small pieces according to the remaining amount of food 3.

In Embodiment 2, estimator 113 can estimate the remaining amount of food 3 based on the size of variable part 42 of food management tag 4A recognized by recognizer 112.

Here, processor 11 or recognizer 112 distinguishes and recognizes invariable part 41 and variable part 42 of food management tag 4A as follows.

As an example, it is assumed that invariable part 41 is provided with a marker which can be identified as invariable part 41, and the small removable pieces of variable part 42 are provided with markers which can be individually identified as the small pieces. In this case, processor 11 or recognizer 112 appropriately performs the image recognition processing on the image captured by imaging element 21, and thereby can recognize invariable part 41 and the small removable pieces of variable part 42.

Processor 11 or recognizer 112 may recognize, among the small removable pieces of variable part 42, the number of small pieces which have not been removed from invariable part 41 or the area of the small pieces which have not been removed. In the former case, processor 11 or recognizer 112 may recognize the number of small pieces which have not been removed from invariable part 41 by counting the number of markers which can be identified as the small pieces. In the latter case, processor 11 or recognizer 112 may recognize the area of the small pieces which have not been removed from invariable part 41 from a change in the area of all the small pieces which have been recognized, Furthermore, when unique features such as unique numbers are individually provided to the small removable pieces of variable part 42, processor 11 or recognizer 112 may recognize which small pieces are left in invariable part 41.

Although a small piece of variable part 42 has been removed from invariable part 41, the small piece may be present in the image captured by imaging element 21. In such a case, for example, when It is found based on a distance from the small piece to invariable part 41 that the small piece is not present in the vicinity of invariable part 41, processor 11 or recognizer 112 can recognize that the small piece has been removed from invariable part 41.

As another example, it is assumed that the same markers are printed on entire invariable part 41 and variable part 42. In this case, processor 11 or recognizer 112 may recognize the amount of change in variable part 42 based on a change in the area of the markers recognized in the image captured by imaging element 21. For example, Information indicating that the ratio of the area of variable part 42 to the area of the markers on entire invariable part 41 and variable part 42 is 10% is assumed to be previously stored in a memory. In this case, when the area of the recognized markers is reduced by 1%, processor 11 or recognizer 112 can estimate that the area of variable part 42 is reduced by 10%, that is, food 3 is consumed by 10%.

The estimation of the remaining amount of food 3 performed by estimator 113 will be specifically described below,

For example, it is assumed that acquirer 111 acquires the captured image shown in part (a) in FIG. 7 at a timing at which the user first puts food 3 into refrigerator 2. In this case, estimator 113 estimates that the remaining amount of food 3 is 100%. Estimator 113 calculates the area “γ” of variable part 42 in a region recognized as food management tag 4A in the captured image shown in part (a) in FIG. 7. The area is stored in storage 12 in association with the identifier of food management tag 4A and food 3 to which food management tag 4A is attached.

For example, it is assumed that acquirer 111 acquires the captured image shown in part (b) in FIG. 7 at a timing at which the user removes, from refrigerator 2, food 3 to which food management tag 4 is attached, and then stores food 3 into refrigerator 2 again. Here, a half of variable part 42 of food management tag 4A has been removed by the hands of the user according to the remaining amount of food 3. Estimator 113 calculates the area “γ/2” of variable part 42 in a region recognized as food management tag 4A in the captured image shown in part (b) in FIG. 7. Then, estimator 113 estimates that the remaining amount of food 3 is 50% by comparison with the area “γ” which is read from storage 12 and indicates that the remaining amount of food 3 is 100%.

In Embodiment 2, instead of food management tag 4A, food management tag 4B shown in FIG. 8 may be attached to food 3. FIG. 8 is a diagram showing an example of food management tag 4B in Embodiment 2, FIG. 8 shows an image captured by imaging, using Imaging element 21, food 3 to which food management tag 4B is attached. In the example shown in FIG. 8, food 3 is cabbage, and food management tag 4B is a package which wraps the cabbage, Here, the package is partially removed or folded by the hands of the user according to the remaining amount of food 3. Hence, food management tag 4B as a whole serves as a variable part. Although not shown in FIG. 8, on food management tag 4B, a plurality of character strings indicating the name and the like of food 3 may be written as the identifier thereof, or food management tag 48 may have a pattern which is different from other food management tags 4B. Food management tag 4B may include, as its identifier, a one-dimensional code such as a barcode, a two-dimensional code such as a QR code (registered trademark), a color code, or the like. These codes may be written on, for example, a piece of paper having an adhesive part, and may be attached to food management tag 48 by sticking the piece of paper to food management tag 4B, In the captured image shown in part (a) in FIG. 8, food 3 is not used. In the captured image shown in part (b) in FIG. 8, a half of food 3 has been used in cooking or the like.

For example, it is assumed that acquirer 111 acquires the captured image shown in part (a) in FIG. 8 at a timing at which the user first puts food 3 into refrigerator 2. In this case, estimator 113 estimates that the remaining amount of food 3 is 100%. Estimator 113 calculates the area “δ” of a region (that is, the variable part) recognized as food management tag 4B in the captured image shown in part (a) in FIG. 8. The area is stored in storage 12 in association with the identifier of food management tag 4B and food 3 to which food management tag 48 is attached.

For example, it is assumed that acquirer 111 acquires the captured image shown in part (b) in FIG. 8 at a timing at which the user removes, from refrigerator 2, food 3 to which food management tag 4B is attached, and then stores food 3 into refrigerator 2 again. Here, a half of food management tag 4B has been removed or folded by the hands of the user according to the remaining amount of food 3. Estimator 113 calculates the area “δ/2” of the region (that is, the variable part) recognized as food management tag 4B in the captured image shown in part (b) in FIG. 8. Then, estimator 113 estimates that the remaining amount of food 3 is 50% by comparison with the area “δ” which is read from storage 12 and indicates that the remaining amount of food 3 is 100%.

### [2. Operation]

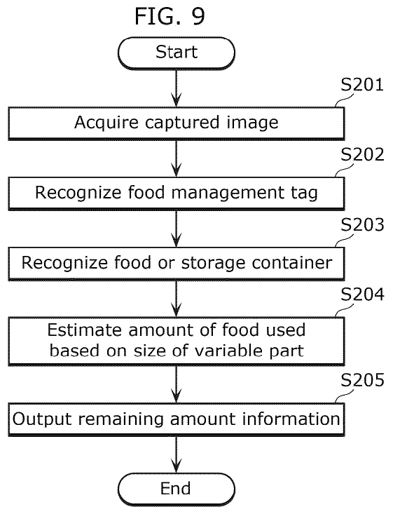

An operation (food management method) of food management system 100B configured as described above will be described below with reference to FIG. 9. FIG. 9 is a flowchart showing an operation example of food management system 100B in Embodiment 2. Acquirer 111 first acquires an image captured by imagining, using imaging element 21, food 3 or storage container 5 to which food management tag 4A or 4B is attached (S201), Here, acquirer 111 acquires, via communication I/F 10, data of the captured image transmitted from communication I/F 22 of refrigerator 2.

Then, recognizer 112 recognizes food management tag 4A or 48 included in the captured image based on the captured image acquired by acquirer 111 (S202). Recognizer 112 also recognizes food 3 or storage container 5 included in the captured image based on the captured image which has been acquired (S203), The order of processing steps S202 and S203 is not limited to this order, and they may be performed In a reverse order or may be performed at the same time.

Then, estimator 113 estimates the remaining amount of food 3 based on the size of variable part 42 of food management tag 4A or 4B recognized by recognizer 112 (S204), Then, outputter 114 outputs remaining amount information related to the remaining amount of food 3 estimated by estimator 113 (S205).

### [3. Advantage and Like]

An advantage of food management system 100B (food management method) in Embodiment 2 will be described below. In food management system 100B (food management method) in Embodiment 2, as has already been described, the remaining amount of food 3 Is estimated based on only the size of food management tag 4A (here, the size of variable part 42) without reference to the size of food 3 or storage container 5. Hence, advantageously, in food management system 100B (food management method) in Embodiment 2, the size of variable part 42 of food management tag 4A or 4B can be recognized, and thus the remaining amount of food 3 can be estimated without the size of food 3 or storage container 5 being recognized, with the result that it is possible to reduce a processing load.

### [4. Variation of Embodiment 2]

A variation of Embodiment 2 will be illustrated below,

Although in Embodiment 2, food management tag 4B is the package which wraps food 3, food management tag 4B is not limited to the package. For example, the food management tag may be an edible ink. In this case, the food management tag is directly printed on food 3. In this case, as in the case where the food management tag is the package, the size of the food management tag is changed according to the remaining amount of food 3, and thus estimator 113 references the size of the food management tag (variable part) to be able to estimate the remaining amount of food 3.

Furthermore, the food management tag may be a transparent ink. In this case, since the food management tag itself has no design, it is possible to print the food management tag on entire food 3 without worrying about a change in the design caused by printing the food management tag on food 3. For example, the transparent ink may include a material which reacts to light of a specific wavelength other than visible light such as infrared light. In other words, when the food management tag is the transparent ink, it is difficult for the human eye to recognize the food management tag because the food management tag hardly reflects visible light even when visible light is incident on the food management tag. On the other hand, when light of a specific wavelength such as infrared light is incident on the food management tag, the light is reflected, the reflected light is received by imaging element 21, and thus it is possible to image the food management tag, In this case, Imaging element 21 is configured not to include a filter which blocks the light of the specific wavelength.

In Embodiment 2, estimator 113 may perform, together with the estimation processing described above, the estimation processing performed by estimator 113 in Embodiment 1, that is, the processing for estimating the remaining amount of food by comparing the size of food management tag 4A (here, invariable part 41) with the size of food 3 or storage container 5. In this case, estimator 113 may use the average value of the results of both the estimation processing steps as the remaining amount of food 3.

### Variations

The embodiments have been described above as examples of the technique disclosed in the present application, However, the technique in the present disclosure is not limited to the embodiments described above, and can be applied to embodiments obtained by performing change, replacement, addition, omission, and the like as necessary. It is also possible to newly form embodiments by combining the constituent elements described in the above embodiments.

Hence, variations common to the embodiments described above will be illustrated below.

In the embodiments described above, food management tags 4, 4A, and 4B may Include a material which reflects light of a specific wavelength. Here, the light of the specific wavelength is, for example, illumination light, near-infrared light, or the like which is applied to the interior of refrigerator 2. In this case, for example, when imaging is performed using imaging element 21 installed inside refrigerator 2, food management tags 4, 4A, and 48 reflect the light of the specific wavelength, and thus imaging is easily performed using imaging element 21. In other words, in this case, advantageously, in a state where the light of the specific wavelength is applied, food management tags 4, 4A, and 4B are imaged clearly and easily using Imaging element 21,

Although in the embodiments described above, food 3 or storage container 5 is stored in refrigerator 2, the present disclosure is not limited to this configuration. For example, food 3 or storage container 5 may be stored in a storage space, other than refrigerator 2, such as a food storage like a pantry. In this case, imaging element 21 and communication I/F 22 may be provided in the storage space.

Although in the embodiments described above, imaging is performed using Imaging element 21 at a timing at which food 3 or storage container 5 is stored or removed into or from refrigerator 2, the present disclosure is not limited to this configuration. For example, imaging element 21 may periodically image the interior of refrigerator 2 regardless of the door of refrigerator 2 being opened or closed.

Although in the embodiments described above, the image captured in refrigerator 2 is transmitted to food management systems 100, 100A, and 100B, the present disclosure is not limited to this configuration. For example, an image captured by an information terminal such as a smartphone owned by the user may be transmitted to food management systems 100, 100A, and 100B. In this case, the information terminal may include imaging element 21 and communication I/F 22. In this case, a series of processing steps for estimating the remaining amount of food 3 in food management system 100, 100A, and 100B is performed, for example, at a timing at which the user operates the information terminal to transmit the captured image to food management systems 100, 100A, and 100B.

Food management tags 4, 4A, and 4B in the embodiments described above can be distributed on the market independently. In other words, food management tags 4, 4A, and 4B are not accessories of food 3 or storage container 5, but can be arbitrarily attached to food 3 or storage container 5 by the user.

For example, although in the embodiments described above, food management systems 100, 100A, and 100B are respectively realized by servers 1, 1A, and 1B, the present disclosure is not limited to this configuration. For example, each of food management systems 100, 110A, and 100B may be realized by the information terminal such as the smartphone owned by the user. In this case, communication I/F 10, processor 11, and storage 12 in each of food management system 100, 100A, and 100B are respectively realized by a communication I/F, a processor, and a storage included in the information terminal.

For example, although in the embodiments described above, each of food management systems 100, 100A, and 100B is realized as a single device, each of food management systems 100, 100A, and 100B may be realized by a plurality of devices. When each of food management systems 100, 100A, and 100B is realized by a plurality of devices, constituent elements Included in each of food management systems 100, 100A, and 100B may be distributed to the devices in any manner. In other words, the present disclosure may be realized by cloud computing or may be realized by edge computing. As an example, each of food management systems 100, 100A, and 100B may be provided in a storage space of refrigerator 2 or the like in which food 3 or storage container 5 is stored.

For example, in the embodiments described above, all or a part of constituent elements in each of food management systems 100, 100A, and 100B in the present disclosure may be formed by dedicated hardware, or may be realized by executing software programs suitable for the constituent elements. A program executor such as a central processing unit (CPU) or a processor may read and execute software programs recorded in a recording medium such as a hard disk drive (HDD) or a semiconductor memory, and thus the constituent elements may be realized.

The constituent elements in each of food management systems 100, 100A, and 100B in the present disclosure may be formed by one or a plurality of electronic circuits. Each of the one or the plurality of electronic circuits may be a general-purpose circuit or a dedicated circuit.

For example, the one or the plurality of electronic circuits may include a semiconductor device, an integrated circuit (IC), a large scale integration (LSI) circuit, or the like. The IC or the LSI circuit may be integrated into one chip or may be integrated into a plurality of chips. Although, here, the electronic circuits are referred to as the IC or the LSI circuit, depending on the degree of integration, they may be referred to as a system LSI circuit, a very large scale Integration (VLSI) circuit, or an ultra large scale integration (ULSI) circuit, A field programmable gate array (FPGA) which is programmed after the manufacturing of an LSI circuit can be used for the same purpose.

General or specific forms in the present disclosure may be realized by systems, devices, methods, integrated circuits, or computer programs. They may also be realized by a non-transitory computer-readable recording medium such as an optical disc, an HDD or a semiconductor memory in which the computer programs are stored, For example, the present disclosure may be realized as programs for causing a computer to execute a proposal method in each of the embodiments described above. The programs may be recorded in a non-transitory recording medium such as a computer-readable CD-ROM, or may be distributed via a communication path such as the Internet.

As examples of the technique in the present disclosure, the embodiments have been described above. Hence, the accompanying drawings and the detailed description have been provided.

Therefore, the constituent elements in the accompanying drawings and the detailed description can include not only constituent elements which are essential for solving the issue but also constituent elements which are not essential for solving the issue in order to Illustrate the technique. Hence, the fact that these non-essential constituent elements are described in the accompanying drawings and the detailed description should not be interpreted as indicating that these non-essential constituent elements are essential.

The embodiments described above are intended for illustrating the technique in the present disclosure, and thus various types of change, replacement, addition, omission, and the like can be performed in the scope of claims or in a scope equivalent thereto.

### Summary

As described above, the food management method in each of the embodiments includes acquiring an image captured by imaging, using imaging element 21, food 3 or storage container 5 to which food management tag 4, 4A, or 4B including an identifier associated with food 3 is attached, and storage container 5 stores food 3 (S101 and S201). The food management method includes recognizing, based on the image acquired, food 3 or storage container 5 to which food management tag 4, 4A, or 4B is attached (S102, S103, S202, and $203). The food management method includes estimating the remaining amount of food 3 based on the size of food management tag 4, 4A, or 48 recognized (S104 and S204). The food management method includes outputting remaining amount information related to the remaining amount of food 3 that has been estimated (S105 and S205).

In this way, advantageously, the remaining amount of food 3 can be grasped by referencing the remaining amount of food 3 which has been estimated, and thus food 3 is easily managed as compared with a case where food 3 is simply identified.

For example, in the food management method, the remaining amount of food 3 is estimated by comparing the size of food management tag 4 or 4A recognized with the size of food 3 or storage container 5 recognized.

In this way, advantageously, as compared with a case where only the size of food 3 is referenced, the accuracy of the estimation of the remaining amount of food 3 is easily enhanced.

For example, the food management method further includes recognizing the type of food 3 based on the Image acquired.

In this way, advantageously, not only the remaining amount of food 3 but also the type of food 3 can be managed, and thus food 3 Is easily managed in more detail.

For example, food management tag 4A or 4B includes variable part 42, the size of which is variable according to the remaining amount of food 3. In the food management method, the remaining amount of food 3 is estimated based on the size of variable part 42 of food management tag 4A or 4B recognized.

In this way, advantageously, the size of variable part 42 of food management tag 4A or 4B can be recognized, and thus the remaining amount of food 3 can be estimated without the size of food 3 or storage container 5 being recognized, with the result that it is possible to reduce a processing load,

For example, the food management method further includes acquiring sound information that is collected by microphone 25 and is related to the remaining amount of food 3. In the food management method, in the outputting of the remaining amount information, information that is based on the sound information acquired and is related to the remaining amount of food 3 is included in the remaining amount information.

In this way, advantageously, for example, when an estimation model for estimating the remaining amount of food 3 is retrained by machine learning, a data set for retraining with the actual remaining amount of food 3 used as correct data is easily collected

For example, the imaging using imaging element 21 is performed at a timing at which the user puts food 3 or storage container 5 into a storage space (refrigerator 2) or at a timing at which the user removes food 3 or storage container 5 from the storage space.

In this way, advantageously, the remaining amount of food 3 can be estimated at a timing at which food 3 is highly likely to be used, and thus the remaining amount of food 3 is managed accurately and easily.

For example, food management tag 4, 4A, or 48 includes a material that reflects light of a specific wavelength.

In this way, advantageously, in a state where the light of the specific wavelength is applied, food management tag 4, 4A, or 4B is Imaged clearly and easily using imaging element 21.

A program in each of the embodiments causes one or more processors to execute the food management method described above.

In this way, advantageously, the remaining amount of food 3 can be grasped by referencing the remaining amount of food 3 which has been estimated, and thus food 3 is easily managed as compared with a case where food 3 is simply identified.

Food management system 100, 100A, or 100B in each of the embodiments includes acquirer 111, recognizer 112, estimator 113, and outputter 114. Acquirer 111 acquires an image captured by Imaging, using imaging element 21, food 3 or storage container 5 to which food management tag 4, 4A, or 4B including an identifier associated with food 3 is attached, and storage container 5 stores food 3. Recognizer 112 recognizes, based on the image acquired by acquirer 111, food 3 or storage container 5 to which food management tag 4, 4A, or 4B is attached. Estimator 113 estimates the remaining amount of food 3 based on the size of food management tag 4, 4A, or 4B recognized by recognizer 112, Outputter 114 outputs remaining amount information related to the remaining amount of food 3 that has been estimated by estimator 113.

In this way, advantageously, the remaining amount of food 3 can be grasped by referencing the remaining amount of food 3 which has been estimated, and thus food 3 is easily managed as compared with the case where food 3 is simply identified,

Food management tag 4A or 4B in each of the embodiments is attached to food 3 or storage container 5 for storing food 5, and includes an identifier associated with food 3, and food management tag 4A or 4B includes variable part 42, the size of which is variable according to the remaining amount of food 3.

In this way, advantageously, the remaining amount of food 3 can be grasped by attaching food management tag 4A or 4B to food 3 or storage container 5, and thus food 3 is easily managed as compared with a case where a tag for identifying food 3 is simply attached to food 3 or storage container 5.

For example, variable part 42 is removable by the user according to the remaining amount of food 3.

In this way, advantageously, the user can change the size of variable part 42 according to the remaining amount of food 3, and thus the accuracy of the estimation of the remaining amount of food 3 based on the size of variable part 42 is easily enhanced.

### INDUSTRIAL APPLICABILITY

The present disclosure can be applied to a system and the like which manage food,

### REFERENCE SIGNS LIST

1, 1A, 1B server
100, 100A, 100B food management system
10 communication I/F
11 processor
111 acquirer
112 recognizer
113 estimator
114 outputter
12 storage
2 refrigerator (storage space)
21 Imaging element
22 communication I/F
23 processor
24 storage
25 microphone
3 food
4, 4A, 4B food management tag
41 invariable part
42 variable part
5 storage container
51 first storage container
52 second storage container
NT1 external network

1. A food management method comprising:
acquiring an image captured by imaging, using an imaging element, food or a storage container to which a food management tag including an identifier associated with the food is attached, the storage container storing the food,
recognizing, based on the image acquired, the food or the storage container to which the food management tag is attached;
estimating a remaining amount of the food based on a size of the food management tag recognized; and
outputting remaining amount information related to the remaining amount of the food that has been estimated.

2. The food management method according to claim 1,
wherein the remaining amount of the food is estimated by comparing the size of the food management tag recognized with a size of the food or the storage container recognized.

3. The food management method according to claim 2, further comprising:
recognizing a type of the food based on the image acquired.

4. The food management method according to claim 1,
wherein the food management tag includes a variable part, a size of which is variable according to the remaining amount of the food, and
the remaining amount of the food is estimated based on the size of the variable part of the food management tag recognized.

5. The food management method according to claim 1, further comprising:
acquiring sound information that is collected by a microphone and is related to the remaining amount of the food,
wherein in the outputting of the remaining amount information, information that is based on the sound information acquired and is related to the remaining amount of the food is included in the remaining amount information.

6. The food management method according to claim 1,
wherein the imaging using the imaging element is performed at a timing at which a user puts the food or the storage container into a storage space or at a timing at which the user removes the food or the storage container from the storage space.

7. The food management method according to claim 1,
wherein the food management tag includes a material that reflects light of a specific wavelength.

8. A non-transitory computer-readable recording medium having recorded thereon a program for causing one or more processors to execute:
the food management method according to claim 1.

9. A food management system comprising:
an acquirer that acquires an image captured by imaging, using an imaging element, food or a storage container to which a food management tag including an identifier associated with the food is attached, the storage container storing the food,
a recognizer that recognizes, based on the image acquired by the acquirer, the food or the storage container to which the food management tag is attached;
an estimator that estimates a remaining amount of the food based on a size of the food management tag recognized by the recognizer; and
an outputter that outputs remaining amount information related to the remaining amount of the food that has been estimated by the estimator.

10. A food management tag that is attached to food or a storage container for storing
the food and includes an identifier associated with the food, the food management tag comprising:
a variable part, a size of which is variable according to a remaining amount of the food.

11. The food management tag according to claim 10,
wherein the variable part is removable by the user according to the remaining amount of the food by a user.

12. The food management method according to claim 1,
wherein the food management tag is a transparent ink.

13. The food management method according to claim 1,
wherein the remaining amount information is further associated with a storage location of the food.
